(19) United States
(12) Patent Application Publication
(10) Pub. No.: US 2005/0157631 A1
(43) Pub. Date: Jul. 21, 2005

(54) Information storage medium and method and apparatus for reproducing information recorded on the same

(75) Inventors: Kyung-geun Lee, Seongnam-si (KR); In-oh Hwang, Yongin-si (KR); Joo-ho Kim, Yongin-si (KR); Du-seop Yoon, Seongnam-si (KR); Hyun-ki Kim, Suwon-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD, Suwon-si (KR)

(21) Appl. No.: 11/019,136

(22) Filed: Dec. 22, 2004

(30) Foreign Application Priority Data
Dec. 30, 2003 (KR) 2003-100544
Feb. 27, 2004 (KR) 2004-13576
Oct. 4, 2004 (KR) 2004-78745

(51) Int. Cl. G11B 7/24; G11B 5/58

(52) U.S. Cl. 369/275.3; 369/275.4; 369/53.2

(57) ABSTRACT

An information storage medium having a structure in which a data region is a super resolution region and a data control region is a standard region, and a method and apparatus reproducing information recorded on the information storage medium and information recorded on a standard information storage medium. The information storage medium includes a recording mark smaller than a resolving power of a beam irradiated from the apparatus, wherein control data including information regarding the type of medium is recorded in a predetermined region. The apparatus reproducing information from a first information storage medium having a recording mark smaller than a resolving power of an irradiated beam and in which control data including information regarding the type of medium is recorded on a predetermined region, and a second information storage medium having a recording mark larger than the resolving power of the irradiated beam, the apparatus including a pickup unit having a light source irradiating a beam; and a photodetector detecting a reproduction signal and a discriminating signal, indicating information regarding the type of the loaded medium, and a signal processor determining the type of the loaded medium based on the discriminating signal and setting a reproduction power of the beam irradiated from the light source according to the result of the determination.

### CROSS-REFERENCE TO RELATED APPLICATIONS

This application claims the benefit of Korean Patent Application Nos. 2003-100544, filed on Dec. 30, 2003, 2004-13576, filed on Feb. 27, 2004, and 2004-78745, filed on Oct. 4, 2004, respectively, in the Korean Intellectual Property Office, the disclosures of which are incorporated herein by reference.

### BACKGROUND OF THE INVENTION

1. Field of the Invention

The present invention relates to an information storage medium using a super resolution phenomenon and a method and apparatus reproducing information recorded on the information storage medium, and more particularly, to an information storage medium having a structure in which a data region is a super resolution region and a data control region is a standard region, and a method and apparatus compatibly reproducing information recorded on a super resolution information storage medium (hereinafter, referred to as an SRISM) and information recorded on a standard information storage medium.

2. Description of the Related Art

In general, an information storage medium is used in an optical pickup device that records and/or reproduces information in a non-contact manner. Demand for information storage media with higher recording densities has increased over time.

To meet this demand, an information storage medium using a super resolution phenomenon is being researched. The information storage medium includes marks that are smaller than a resolving power of a laser beam. In this case, when the wavelength of a laser beam is λ and a numerical aperture of an objective lens is NA, a reproduction resolving power is λ/4NA.

An information storage medium using the super resolution phenomenon includes a mask layer on which surface plasmon is generated by an incident beam and produces high density recording by using the surface plasmon when reproducing information.

For example, if the mask layer is composed of PtOx, when irradiating a laser beam onto the mask layer, the PtOx is decomposed into Pt and O₂ by the laser beam. Surface plasmon is generated by the decomposed Pt and near field reproduction becomes possible. Therefore, signal reproduction of a recording mark smaller than the resolving power of the laser beam becomes possible.

When reproducing information from an SRISM with an optical pickup device including a light source irradiating light at a wavelength of 405 nm and an objective lens having a numerical aperture of 0.85, a signal is detected at a reproduction power of over approximately 1.2 mW. On the other hand, when a standard (non-super resolution) information storage medium on which information is reproduced using the above-described optical pickup device, a signal is detected at a reproduction power of approximately 0.35 mW.

In other words, according to an aspect of optical configuration and reproduction power control of the optical pickup device, an optical pickup device that can reproduce information from the SRISM, can also reproduce information from a standard information storage medium having a lower recording density than that of the SRISM. However, different reproduction powers are used to reproduce the SRISM and the standard information storage medium. That is, information cannot be reproduced from a conventional SRISM at a reproduction power at which information can be reproduced from a standard information storage medium. And when reproducing information from the standard information storage medium by irradiating a beam having a reproduction power of approximately 1.0 mW, which is appropriate for the SRISM, data recorded on the standard information storage medium can be damaged. For example, when irradiating a beam having a reproduction power of approximately 1.2 mW onto a phase variation optical disk, due to the high reproduction power, a recorded mark is deteriorated, and accordingly, information may be corrupted. In addition, deterioration of a phase variation recording layer occurs even in a portion of the information storage medium on which information is not recorded, and therefore, information cannot be recorded in said portion.

As a result, when using the reproduction power of the above-described optical pickup device suitable for the SRISM, the standard information storage medium having a relatively low recording density cannot be compatibly employed.

### SUMMARY OF THE INVENTION

According to an aspect of the present invention, there is provided an information storage medium in which control data indicating the type of medium that can be read by irradiating a beam having relatively low reproduction power used for a standard information storage medium.

According to an aspect of the present invention, there is also provided an apparatus reproducing information which can compatibly reproduce information recorded on a super resolution information storage medium (SRISM) and information recorded on a standard information storage medium.

According to an aspect of the present invention, there is also provided a method of compatibly reproducing information recorded on an SRISM and information recorded on a standard information storage medium.

According to an aspect of the present invention, there is provided an information storage medium including a recording mark smaller than a resolving power of a beam irradiated from an apparatus reproducing information, wherein control data including information regarding the type of medium recorded in a predetermined region has a standard structure.

According to an aspect of the present invention, there is provided an information storage medium may be divided into a lead-in region, a data region, and a lead-out region, and the control data may be recorded on at least a portion of the lead-in region and/or the lead-out region.

According to another aspect of the present invention, there is provided an information storage medium including a lead-in region, a data region, and a lead-out region, wherein the data region includes recording marks smaller than a resolving power of a beam irradiated from an apparatus reproducing information, and the lead-in region and/or the lead-out region includes a standard reproduction region formed of recording pits larger than the resolving power and a super resolution reproduction region having recording pits smaller than the resolving power.

When the depths of the recording pits of the standard reproduction region are d1, the depth of the recording pits that are smaller than the resolving power included in the super resolution reproduction region is d2 and the depth of the recording pits that are larger than the resolving power included in the super resolution reproduction region is d3 and the depth of a recording pit or a groove forming the data region is d4, the depths d1, d2, d3, and d4 satisfy

$$\begin{matrix}\frac{λ}{7 n} \leq {d}_{1} \leq \frac{λ}{3 n} \\ \frac{λ}{10 n} \leq {d}_{2} \leq \frac{λ}{6 n} \\ \frac{λ}{8 n} \leq {d}_{3} \leq \frac{λ}{4 n} \\ \frac{λ}{13 n} \leq {d}_{4} \leq \frac{λ}{8 n} .\end{matrix}$$

According to still another aspect of the present invention, there is provided an apparatus reproducing information from a first information storage medium which has a recording mark smaller than a resolving power of an irradiated beam and in which control data including information regarding the type of medium is recorded on a predetermined region having a standard structure, and a second information storage medium which is recorded with a recording mark larger than the resolving power of the beam, which is irradiated on the entire second information storage medium. The apparatus including a pickup unit having: a light source irradiating a beam with a predetermined power on a loaded information storage medium; and a photodetector receiving the beam reflected from the loaded information storage medium and detecting a reproduction signal and a discriminating signal, which indicates information regarding the type of the loaded medium; and a signal processor determining the type of the loaded medium based on the discriminating signal detected by the photodetector and setting a reproduction power of the beam irradiated from the light source according to the result of determination.

According to yet another aspect of the present invention, there is provided a method of reproducing information from a first information storage medium which has a recording mark smaller than a resolving power of an irradiated beam and in which control data including information regarding the type of medium is recorded on a predetermined region having a standard structure, and a second information storage medium which is recorded with a recording mark larger than the resolving power of the beam, which is irradiated on the entire second information storage medium. The method including irradiating on a loaded information storage medium a beam with a reproduction power used for reproducing information from the second information storage medium; receiving the beam reflected from the loaded information storage medium and determining the type of information storage medium based on control data regarding the loaded information storage medium; and if determined that the first information storage medium is loaded, irradiating a beam with a reproduction power relatively higher than the reproduction power used for reproducing information from the second information storage medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become more apparent and more readily appreciated from the following description of the embodiments, taken in conjunction with the attached drawings of which:

FIG. 1 is a cross-sectional view of a super resolution information storage medium (SRISM);

FIG. 2 is a graph of carrier-to noise ratio (CNR) characteristics against the length of a recording mark in the SRISM of FIG. 1;

FIG. 3 is a graph illustrating CNR characteristics against reproduction power when reproducing a recording mark with a length of 75 nm from the SRISM of FIG. 1;

FIG. 4 illustrates an SRISM according to an embodiment of the present invention;

FIG. 5 is a table illustrating the layout of regions of the SRISM shown in FIG. 4;

FIG. 6 is a graph illustrating the amplitude ratio of a reproduction signal with respect to pit depth of a standard reproduction region of the information storage medium shown in FIG. 4;

FIG. 7 is a graph illustrating a sum signal and a pushpull (PP) signal, which indicates a tracking error signal, with respect to groove depth;

FIG. 8 is a graph illustrating a PPb signal with respect to groove depth obtained from FIG. 7;

FIG. 9 is a schematic diagram of an apparatus reproducing information according to an embodiment of the present invention; and

FIG. 10 is a flowchart illustrating a method of reproducing information according to an embodiment of the preset invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

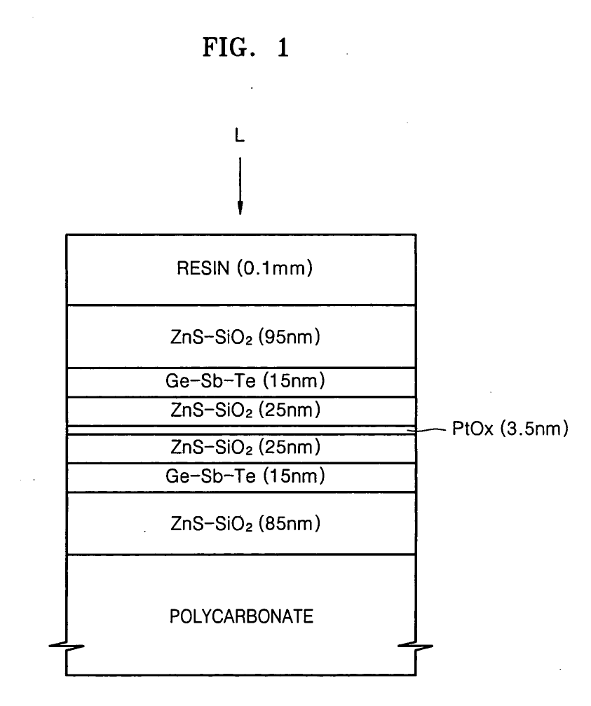

Referring to FIG. 1, the SRISM includes a substrate composed of polycarbonate, a dielectric layer composed of ZnS—SiO₂ with a thickness of approximately 85 nm formed on the substrate, a recording auxiliary layer composed of Ge—Sb—Te with a thickness of approximately 15 nm, a dielectric layer composed of ZnS—SiO₂ with a thickness of approximately 25 nm, a recording layer composed of platinum oxide (PtOx) with a thickness of approximately 3.5 approximately nm, a dielectric layer composed of ZnS—SiO₂ with a thickness of approximately 25 nm, a recording auxiliary layer composed of Ge—Sb—Te with a thickness of approximately 15 nm, a dielectric layer composed of ZnS—SiO₂ with a thickness of approximately 95 nm, and a cover layer composed of resin with a thickness of approximately 0.1 mm formed by spin coating. The SRISM is reproduced by irradiating a laser beam L through the cover layer.

In other words, when irradiating the laser beam L onto the recording layer, platinum oxide (PtOx), which constitutes the recording layer, is decomposed into Pt and O₂ by the irradiated beam L. The decomposed Pt generates surface plasmon and near field reproduction is possible due to the surface plasmon and a reproduction signal of a recording mark having a size smaller than the resolving power of the laser beam condensed on the SRISM by an objective lens is also possible. For example, when the resolving power of the optical pickup device is 119 nm, reproduction of a recording mark smaller than 75 nm is possible.

FIG. 2 illustrates a carrier-to noise ratio (CNR) plotted against the length of a recording mark using an optical pickup device with a resolving power of 119 nm and including a light source irradiating light at 405 nm wavelength and an objective lens with a numerical aperture (NA) of 0.85.

Referring to FIG. 2, a recording mark with a length of 75 nm or 100 nm can be reproduced by the optical pickup device with a resolving power of 119 nm, since a CNR of approximately 40 dB is obtainable.

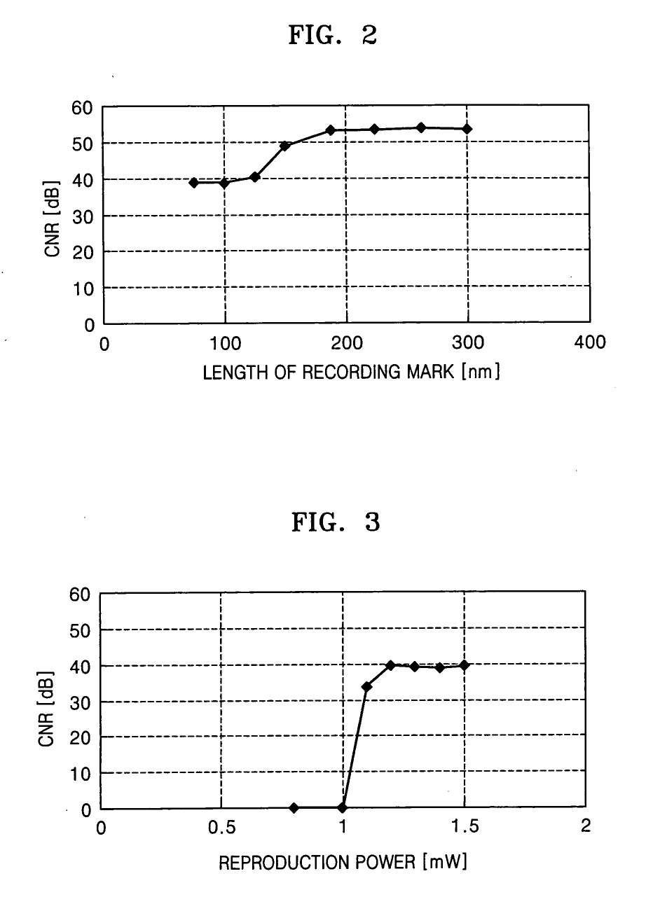

FIG. 3 is a graph illustrating CNR characteristics according to the reproduction power when reproducing a recording mark with a length of 75 nm using an optical pickup device having a resolving power of 119 nm and including a light source irradiating light at a wavelength of 405 nm and an objective lens with an NA of 0.85.

Referring to FIG. 3, for a recording mark with a length of 75 nm, a stable CNR greater than about 40 dB can only be obtained at a reproduction power greater than approximately 1.2 mW. In other words, CNR required for reproduction cannot be obtained at a low reproduction power. This is because a super resolution effect appears only when more than a minimum amount of light is irradiated or the temperature of the inside of the SRISM exceeds a certain temperature.

Therefore, the optical pickup device, which irradiates a laser beam at the reproduction power suitable for the SRISM, cannot be used with a standard information storage medium, which can be reproduced by a laser beam with a relatively low reproduction power.

Considering the above, an SRISM according to an embodiment of the present invention includes a recording mark smaller than a resolving power of the beam irradiated from an information reproduction device and is characterized in that control data recorded at a predetermined region of the SRISM has a standard structure.

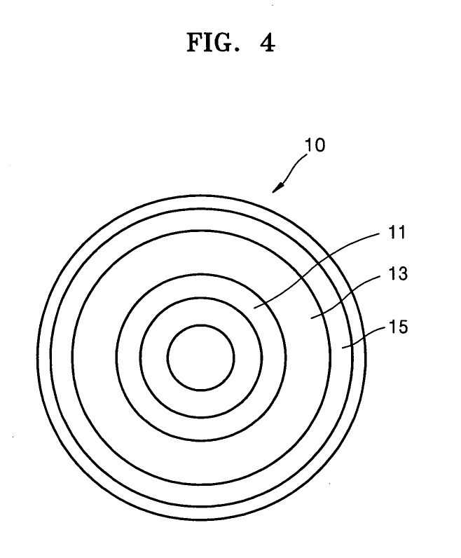

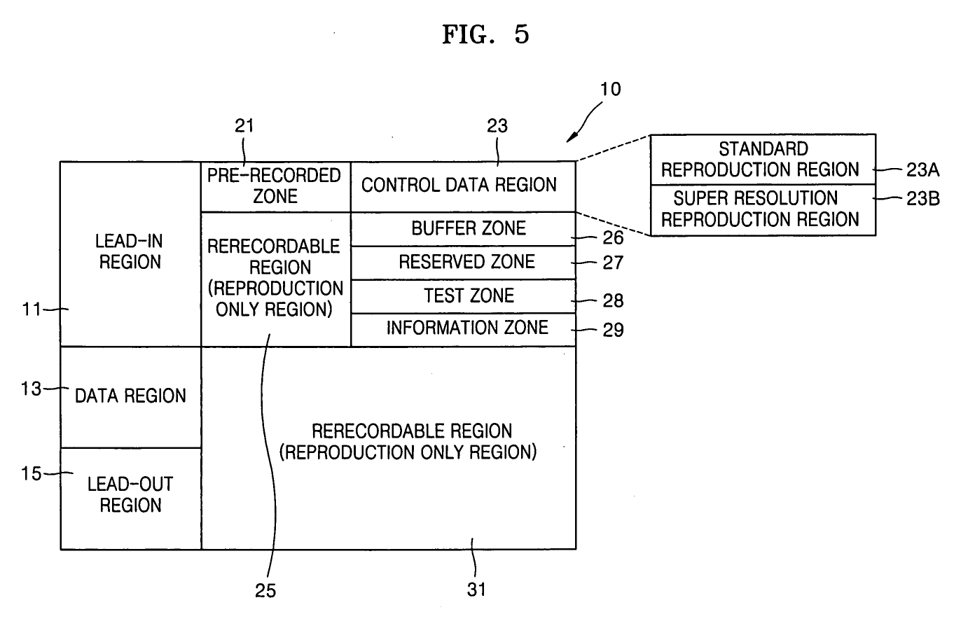

Referring to FIGS. 4 and 5, an SRISM 10 according to an embodiment of the present invention is divided into a data region 13 in which user data is recorded, a lead-in region 11 disposed inside the inner circumference of the data region 13, and a lead-out region 15 disposed outside the outer circumference of the data region 13.

A predetermined amount of information, which will be described later, is pre-recorded on at least a predetermined portion of the lead-in region 11, and the predetermined portion of the lead-in region 11 is used as a pre-recorded zone 21 in which the recorded data is not changed. In addition, the rest of the lead-in region 11 is used as a re-recordable region (or a reproduction only region) 25.

The pre-recorded zone 21 is used as a control data region 23 in which information regarding the SRISM 10 is recorded. The control data includes the type of the SRISM 10, and the optimum recording power and reproduction power for the SRI SM 10.

The control data region 23 includes a standard (non-super resolution) reproduction region 23A in which the recording mark is larger than the resolving power of the beam irradiated from the information reproduction device, and a super resolution reproduction region 23B in which a recording mark is smaller than the resolving power of the beam. The super resolution reproduction region 23B is not essential, and the entire control data region 23 may be the standard reproduction region 23A.

When the wavelength of the laser beam of the information reproduction device, which is used to reproduce information from the SRISM 10, is λ and a numerical aperture of the objective lens is NA, the resolving power of the irradiated beam is λ/4NA. In this case, the control data recorded on the standard reproduction region 23A may be a pre-pit mark, a pre-recorded mark that is larger than the resolving power (λ/4NA), or a wobble.

The control data stored on the SRISM 10 can be read by irradiating the laser beam with a low reproduction power of approximately 0.35 mW, unlike in a conventional super resolution information storage device. Such low reproduction power is used for reproducing information from a general standard optical information storage medium.

Therefore, since information regarding the type of the SRISM 10 can be obtained through low reproduction power, an information reproducing device can read the control data from both the SRISM 10 but also a standard information storage medium that has a relatively low recording density without damaging the control data. In addition, the information storage device can determine whether a storage medium is the SRISM 10 from the information read and can adjust the reproduction power of the laser beam to be used on the basis of the above, such that a standard information storage medium that has a relatively low density can be compatibly employed with the SRISM 10.

A re-recordable region 25 of the lead-in region 11 indicates a region on which the user data is recorded when the SRISM 10 is used as a worm (write once read many times) type or a re-recordable type. The re-recordable region 25 includes a buffer zone 26, a reserved zone 27, a test zone 28, and an information zone 29. The data region 13 and lead-out region 15 are included in a re-recordable region (or a reproduction only region) 31.

In addition, when the SRISM includes the re-recordable region 25, a land and a groove are formed in a spiral shape on a surface on which information is recorded.

The SRISM 10 may be applied to all reproduction only-type storage media, not just worm-type and re-recordable-type storage media. In this case, portions of the lead-in region 11, the data region 13, and the lead-out region 15 form a reproduction only region and the information signal is recorded in pits that have a predetermined depth.

Since the SRISM 10 has this structure, the information signal reproduction efficiency of the recording mark of each region should be increased. To this end, pits recorded in the standard reproduction region 23A and the super resolution reproduction region 23B have to be less than a predetermined width. In addition, the groove of the re-recordable regions 25 and 31 and pits of the reproduction only region must also meet the predetermined depth condition.

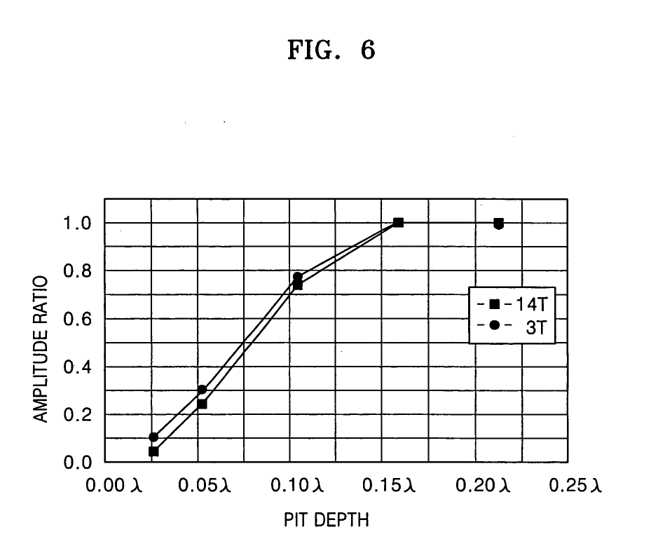

The optimum pit depth and groove depth of each of the above-described regions will now be described with reference to FIGS. 6 through 8.

FIG. 6 is a graph illustrating the amplitude ratio of a reproduction signal with respect to pit depth in the standard reproduction region 23A. That is, FIG. 6 illustrates the result of standardization based on a maximum signal when the length of a recording mark is 3T and when the length is 14T (1T=0.4 μm) using a reproduction signal having the wavelength of 650 nm and an NA of 0.6. This pit depth is labelled in units of λ. The refractive index n of the information storage medium is 1.5.

Referring to FIG. 6, the maximum amplitude ratio occurs when the depth of the pit is larger than λ/4n, that is, larger than approximately 0.167 λ, and as the depth decreases, the amplitude ratios for both the recording lengths of 3T and 14T decrease.

Considering this, d1, which is the depth of the recording pits that form the standard reproduction region 23A, may be in the range of Equation 1.

$$\frac{λ}{7 n} \leq {d}_{1} \leq \frac{λ}{3 n} \qquad ( 1 )$$

Furthermore, when the depth of the recording pits that are smaller than the resolving power included in the super resolution reproduction region 23B is d2 and the depth of the recording pits that are larger than the resolving power included in the super resolution reproduction region 23B, the depths d2 and d3 may be given by Equation 2 described below.

$$\begin{matrix}\frac{λ}{10 n} \leq {d}_{2} \leq \frac{λ}{6 n} \\ \frac{λ}{8 n} \leq {d}_{3} \leq \frac{λ}{4 n}\end{matrix} \qquad ( 2 )$$

By setting the pit depths d2 and d3 described above, the optimum characteristics of the reproduction signal can be obtained. Since the related art is disclosed in Japanese Patent Laid-Open Publication No. 2001-250274 (entitled “Optical Information Medium and Method of Reproducing the Same,” published on Sep. 14, 2001), detailed descriptions thereof will be omitted.

In addition, the groove in the re-recordable region 31, which forms the data region 13, or the pit of the reproduction only region may also satisfy the predetermined depth condition. Referring to FIG. 7, the optimum groove depth setting condition will be described below.

FIG. 7 is a graph illustrating a sum—(sum) signal and a pushpull (PP) signal, which indicates a tracking error signal, with respect to groove depth. Referring to FIG. 7, the PP signal, that is, the tracking error signal, is a sine wave with a maximum value at a groove depth of approximately λ/6 n (=0.111 λ), that is, approximately 72 nm. On the other hand, the sum signal has a maximum value at a relatively shallow depth, and the sum signal monotonously decreases as the groove depth increases.

Both the sum signal and the PP signal are considered when setting the depth of the groove and pit, and to achieve this, a pushpull before (PPb) signal should be checked. The PPb signal is the ratio of the sum signal and the PP signal.

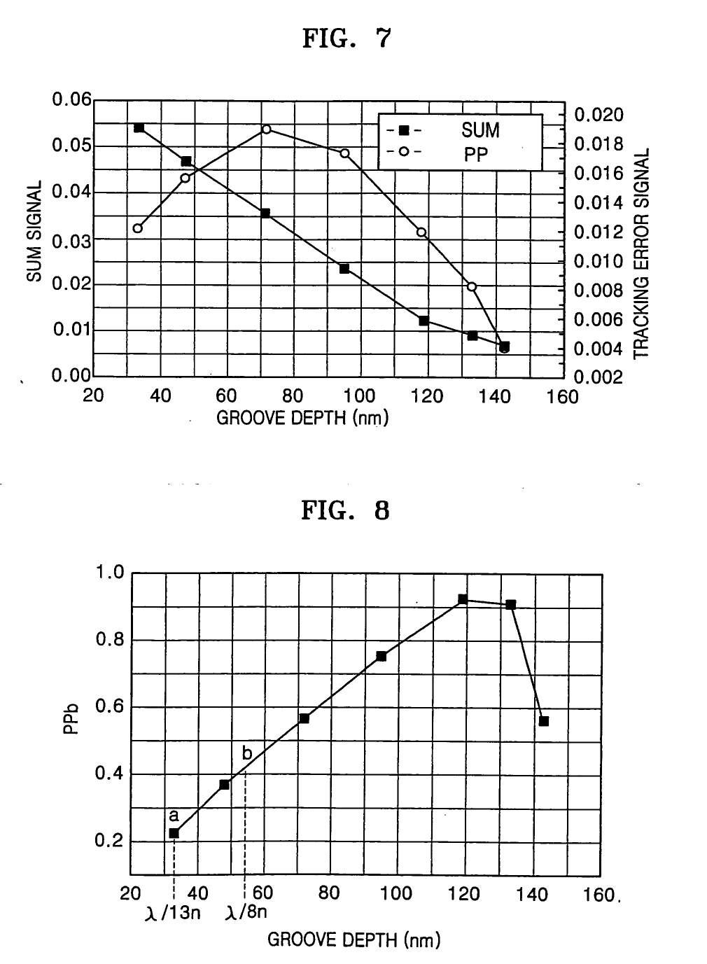

FIG. 8 is a graph illustrating a PPb signal with respect to groove depth. Referring to FIG. 8, the value of the PPb signal is a maximum when the groove depth is greater than λ/6 n (˜72 nm), which is when a pushpull (PP) signal is maximized, that is, approximately λ/3.5 n(˜123 nm).

When taking into consideration the characteristics of the reproduction signal (RF signal), the depth of the groove may be as shallow as possible. As such, according to the current standard of DVD-RW, the value of the PPb signal is set to be within the range of 0.22 to 0.44. In addition, in a DVD-RW and all information storage media that have a super resolution structure according to an embodiment of the present invention, the groove depth is expressed in wavelength λ and a function of refractive index n, which have a mutually proportional relationship.

Therefore, on the basis of the range of the PPb signal which satisfies the standard of the DVD-RW, the groove depth is between point a and point b of FIG. 8, and when the groove depth (or the depth of a recording pit) of the data region is d4, d4 may satisfy the range of Equation 3.

$$\frac{λ}{13 n} \leq {d}_{4} \leq \frac{λ}{8 n} \qquad ( 3 )$$

As a result, the depth of a groove that satisfies the required value of the PPb signal can be set, and the depth of a pit at which a pit signal appears well can be obtained using Equation 2.

By setting the depth of the pit and groove of each region as described above, the information signal reproduction efficiency of recording marks in each region can be increased.

Although control data is recorded on at least a portion of the lead-in region in the present embodiment, the present invention is not limited to this. In other words, the control data can be recorded to the lead-out region, or both the lead-in region and the lead-out region.

An apparatus reproducing information and a method of reproducing information using the apparatus according to embodiments of the present invention will now be described.

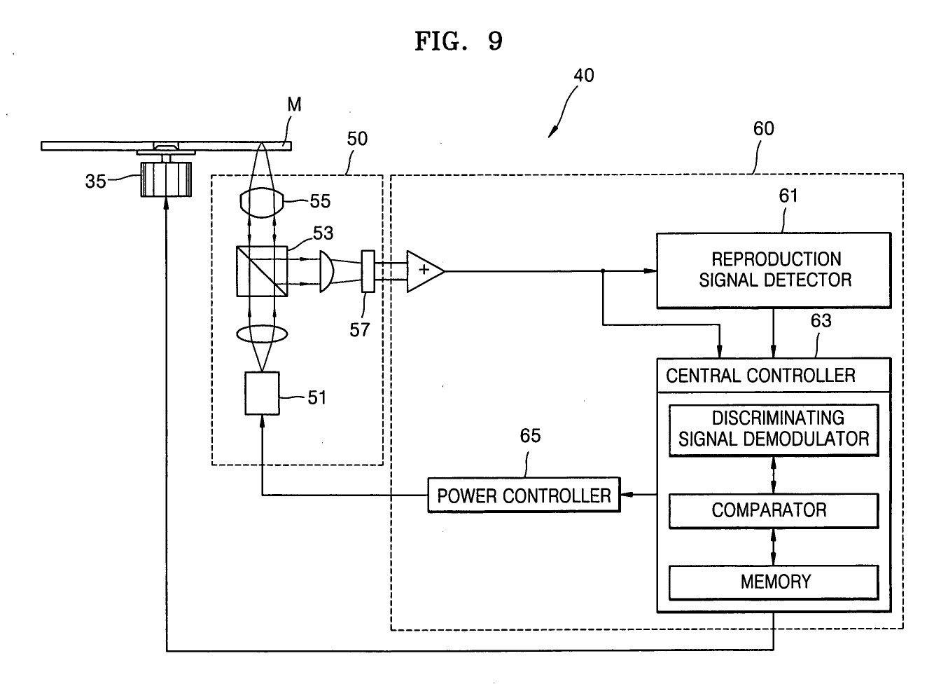

FIG. 9 is a schematic diagram of an apparatus reproducing information according to an embodiment of the present invention. The apparatus 40 of FIG. 9 includes a driver 35 which rotates and drives an information storage medium M, a pickup unit 50 which reads a reproduction signal received from the information storage medium M, and a signal processor 60 which processes the signal that is read.

The pickup unit 50 includes a light source 51, a beam splitter 53 which changes the optical path of an advancing beam, an objective lens 55 which condenses the beam proceeding toward the information storage medium M, and a photodetector 57. The light source 51 irradiates a laser beam with a predetermined power. In other words, the power of the beam irradiated from the light source 51 is variable, and beams of different powers are irradiated when reproducing and recording information and according to the type of information storage medium.

The information storage medium M employed in the apparatus reproducing information can be categorized into first and second information storage media. The first information storage medium is the SRISM according to an embodiment of the present invention, on which the control data is recorded with a standard structure. The control data is recorded on a predetermined region, that is, on at least a portion of a lead-in region and/or a lead-out region and includes information about the type of the medium. Therefore, when reproducing the information from the first information storage medium, the control data is read by irradiating a beam with a relatively low reproduction power, for example, approximately 0.35 mW. The information in the remaining regions is read by irradiating a beam with a power needed for super resolution reproduction, for example, power greater than 1.0 mW.

The second information storage medium is a medium on which a recording mark larger than the resolving power of a beam is recorded in all regions. Optical disks with a memory capacity greater than approximately 20 GB belong in this category. The reproduction of information recorded on the second information storage medium is performed by irradiating a beam with a relatively low reproduction power, for example, approximately 0.35 mW, not only on the control data region but on all data regions.

The photodetector 57 receives the beam reflected from the information storage medium M and detects a reproduction signal and a discriminating signal which indicates information indicating the type of the medium.

The signal processor 60 determines whether the information storage medium M is the first or second information storage medium based on the discriminating signal detected through the photodetector 57 and sets the reproduction power of the beam irradiated from the light source 51. In addition, the signal processor 60 controls the driving source 35 to rotate at a predetermined speed, for example, a linear velocity of 5 m/sec.

To this end, the signal processor 60 includes a reproduction signal detector 61 which detects the level of the reproduction signal read by the photodetector 57, a central controller 63, and a power controller 65 which adjusts the reproduction power of the light source 51.

The central controller 63 determines the type of medium by demodulating discriminating signals read through the reproduction signal detector 61 using a discriminating signal demodulator.

When determined that the medium is the first information storage medium, the power controller 65 controls the light source 51 to irradiate a beam which has a high reproduction power greater than approximately 1.0 mW on the regions excluding the region which has a standard structure, that is, the control data region.

Meanwhile, when it is determined that the medium is the second information storage medium, the power controller 65 controls the light source 51 to irradiate a beam that has an initial reproduction power of, for example, approximately 0.35 mW, for all regions.

Therefore, when carrying out reproduction using the apparatus reproducing information, the first and second information storage media, which require reproduction powers, may be compatibly employed.

A method of reproducing information from the information storage medium using the apparatus reproducing information having the above-described structure will now be described.

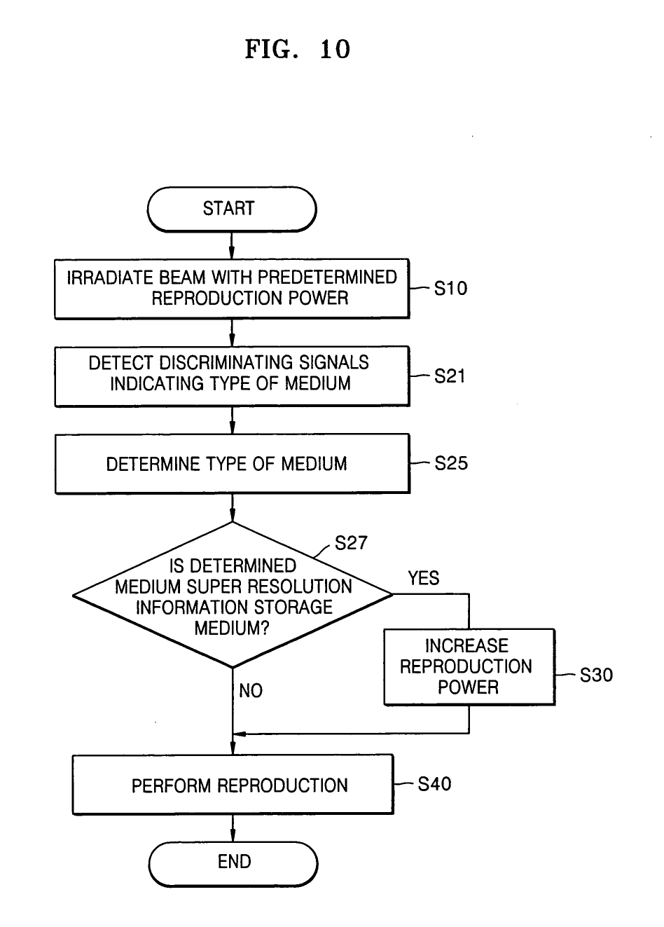

Referring to FIGS. 9 and 10, in operation S10, a beam with a predetermined reproduction power is irradiated on an information storage medium M, which is rotated by a driving source 35. The information storage medium M is one of the first and second information storage media described above and the beam irradiated is initially a laser beam with a relatively low power of 0.35 mW used for reproducing information from the second information storage medium.

Next, in operation S21, the beam reflected from the information storage medium M is received via the photodetector 57 and discriminating signals indicating the type of medium, which is recorded in the control data region, are detected. In operations S25 and S27, it is determined whether the information storage medium M is the first or second information storage medium.

When it is determined that the medium M is the first information storage medium, that is, a super resolution information storage medium (SRISM), the reproduction power of the light source is increased in operation S30. In other words, when it is determined that the first information storage medium is employed, reproduction is performed by irradiating a beam that has a relatively higher reproduction power, greater than approximately 1.0 mW, compared with the reproduction power needed when reproducing information from the second information storage medium in operation S40.

On the other hand, when it is determined that the medium is the second information storage medium, reproduction is performed without increasing the reproduction power in operation S40.

As described above, in an information storage medium according to an aspect of the present invention, information can be reproduced using a recording mark smaller than a diffraction limit of a beam such that the recording density of the information storage medium is increased without lengthening the short wave of a laser diode or increasing a numerical aperture of an objective lens. In addition, by disposing control data regions with a standard structure in a predetermined region, the type of medium can be determined even when using the reproduction power used for a general information storage medium. Furthermore, by setting the pit and groove depth of each region accordingly, information signal reproduction efficiency for the recording mark in each region can be further increased.

In addition, in a method and apparatus reproducing information according to an aspect of the present invention, it is determined whether an employed medium is an SRISM with the above-descried structure or a standard information storage medium, and a reproduction power can be adjusted on the basis of the result of determination such that information storage media requiring different reproduction powers can be compatibly employed.

While the present invention has been particularly shown and described with reference to an exemplary embodiment thereof, it will be understood by those skilled in the art that various changes in form and details may be made therein without departing from the spirit and scope of the invention as defined by the following claims.

1. An information storage medium comprising a recording mark smaller than a resolving power of a beam irradiated from an apparatus reproducing information from the information storage medium, wherein control data including information regarding a type of information storage medium recorded on a predetermined region has a non-super resolution structure.

2. The medium of claim 1, wherein, when a wavelength of the beam is λ and a numerical aperture of an objective lens is NA, the control data is represented by a pre-pit mark or a pre-recorded mark larger than λ/4NA.

3. The medium of claim 1, wherein the control data is represented by a wobble.

4. The medium of claim 1, wherein the information storage medium is divided into a lead-in region, a data region, and a lead-out region; and
the control data is recorded on at least a portion of the lead-in region and/or the lead-out region.

5. The medium of claim 1, wherein the control data is reproduced using a reproduction power of approximately 0.35 mW.

6. An information storage medium comprising a lead-in region, a data region, and a lead-out region, wherein the data region comprises recording marks smaller than a resolving power of a beam irradiated from an apparatus reproducing information, and the lead-in region and/or the lead-out region comprises a standard reproduction region formed of recording pits larger than the resolving power and a super resolution reproduction region comprising recording pits smaller than the resolving power of the irradiated beam.

7. The medium of claim 6, wherein, when depths of the recording pits of the standard reproduction region are d1, and the depths d1 satisfy the following equation:
$$\frac{λ}{7 n} \leq {d}_{1} \leq \frac{λ}{3 n} .$$

8. The medium of claim 6, wherein, when a depth of the recording pits is smaller than the resolving power included in the super resolution reproduction region is d2 and a depth of the recording pits larger than the resolving power included in the super resolution reproduction region is d3, the depths d2 and d3 satisfy the following equation:
$$\begin{matrix}\frac{λ}{10 n} \leq {d}_{2} \leq \frac{λ}{6 n} \\ \frac{λ}{8 n} \leq {d}_{3} \leq \frac{λ}{4 n} .\end{matrix}$$

9. The medium of claim 8, wherein, when a depth of a recording pit or a groove forming the data region is d4, the depth d4 satisfies the following equation:
$$\frac{λ}{13 n} \leq {d}_{4} \leq \frac{λ}{8 n} .$$

10. The medium of claim 6, wherein, when a depth of a recording pit forming the data region is d4, the depth d4 satisfies the following equation:
$$\frac{λ}{13 n} \leq {d}_{4} \leq \frac{λ}{8 n} .$$

11. An apparatus reproducing information from a first information storage medium having a recording mark smaller than a reproduction power of an irradiated beam and in which control data including information regarding a type of medium is recorded on a predetermined region has a non-super resolution structure, and a second information storage medium having a recording mark larger than the reproduction power of the irradiated beam, the apparatus comprising:
a pickup unit comprising:
a light source irradiating the beam with a predetermined reproduction power onto a loaded information storage medium, and
a photodetector receiving the beam reflected from the loaded information storage medium and detecting a reproduction signal and a discriminating signal, which indicates information regarding a type of the loaded medium; and
a signal processor determining the type of the loaded medium based on the discriminating signal detected by the photodetector and setting the reproduction power of the beam irradiated from the light source according to a result of determination.

12. The apparatus of claim 11, wherein the light source irradiates on the first and second information storage media the beam with a reproduction power used for reproducing information from the second information storage medium to determine the type of the loaded information storage medium.

13. The apparatus of claim 12, wherein the reproduction power used to determine the type of the loaded information storage medium is approximately 0.35 mW.

14. The apparatus of claim 12, wherein, when determined from the signal processor that the loaded information storage medium is the first information storage medium, the reproduction power used in reproducing user data is higher than approximately 1.0 mW.

15. The apparatus of claim 11, wherein the signal processor includes a reproduction signal detector detecting a level of the reproduction signal read by the photodetector, a central controller and a power controller adjusting the reproduction power of the light source.

16. The apparatus of claim 15, wherein the central controller determines the type of medium by demodulating the discriminating signal read by the reproduction signal detector using a discriminating signal demodulator.

17. A method of reproducing information from a first information storage medium having a recording mark smaller than a resolving power of an irradiated beam and in which control data including information regarding a type of information storage medium is recorded on a predetermined region has a non-super resolution structure, and a second information storage medium having a recording mark larger than the resolving power of the irradiated beam, the method comprising:
irradiating on a loaded information storage medium the beam with a reproduction power reproducing information from the second information storage medium;
receiving the beam reflected from the loaded information storage medium and determining the type of information storage medium based on the control data regarding the loaded information storage medium; and
if determined that the first information storage medium is loaded, irradiating the beam with a reproduction power higher than the reproduction power reproducing information from the second information storage medium.

18. The method of claim 17, wherein the first information storage medium is divided into a lead-in region, a data region, and a lead-out region; and
the control data is recorded on at least a portion of the lead-in region and/or the lead-out region, and when determining the type of the information storage medium, a laser beam is irradiated on the lead-in region and/or the lead-out region where the control data is recorded.

19. The method of claim 17, wherein the reproduction power used to determine the type of the loaded information storage medium is approximately 0.35 mW.

20. The method of claim 17, wherein, when determined that the loaded information storage medium is the first information storage medium, the reproduction power is higher than approximately 1.0 mW.

21. A method of reproducing information from a first type of information storage medium having a recording mark smaller than a resolving power of an irradiated beam, and reproducing the information from a second type of information storage medium having a recording mark larger than the resolving power of the irradiated beam, the method comprising:
irradiating the beam onto the first or second type of information storage medium with a predetermined reproduction power and determining whether the information storage medium is of the first or second type based on control data recorded on a predetermined region of the first or second type of information storage medium; and
if determined that the medium is of the first type, irradiating the first type of information storage medium with the beam having the reproduction power relatively higher than the reproduction power for reproducing information from the second type of information storage medium.

22. The method of claim 21, wherein the reproduction power of the irradiated beam used to determine the type of information storage medium is approximately 0.35 mW.

23. The method of claim 21, wherein, when determined that the information storage medium is of the first type, the reproduction power of the irradiated beam used to reproduce the information from the first type of information storage medium is higher than approximately 1.0 mW.

24. The method of claim 21, wherein by disposing the control data on the predetermined region having a standard structure, the type of medium is determined even when using the reproduction power used for a general information storage medium.

25. The method of claim 21, wherein by setting a pit and a groove depth of the predetermined region, information reproduction efficiency of the recording mark increases.

26. The method of claim 21, wherein the first and second types of information storage mediums include a super resolution information storage medium (SRISM) and a standard information storage medium, and the reproduction power is adjusted based on the type of medium.
